(19) United States
(12) Patent Application Publication
(10) Pub. No.: US 2009/0320065 A1
(43) Pub. Date: Dec. 24, 2009

(54) CONTENT SELECTION AND OUTPUT

(75) Inventors: David H. Sloo, Menlo Park, CA (US); Peter T. Barrett, San Francisco, CA (US); Gionata Mettifogo, Menlo Park, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/144,609

(22) Filed: Jun. 23, 2008

(51) Int. Cl. H04N 5/445

(52) U.S. Cl. 725/37

(57) ABSTRACT

Content selection and output techniques are described. In an implementation, a user interface is output at a client device that provides for selection of television content via a website for output on a television. A communication is formed to be communicated to the website based on interaction with the user interface to cause the television content to be output by the television automatically and without user intervention.

### BACKGROUND

Users are continually exposed to an ever increasing variety of clients. For example, a user may own a client device such as a wireless phone, television, computer, game console and so on. Further, the functionality available from each of these client devices is ever increasing. A wireless phone, for instance, may be used to make and receive telephone calls, perform instant messaging and/or text messaging, “surf” the web, compose and receive email, and so forth. Traditional interaction with the various client devices, however, was often disjointed even in instances in which different types of client devices were configured to consume similar content. For example, traditional interaction with content was performed within the bounds of the client device itself and was not shared across client devices.

### SUMMARY

Content selection and output techniques are described. In an implementation, a user interface is output at a client device that provides for selection of television content via a website for output on a television. A communication is formed to be communicated to the website based on interaction with the user interface to cause the television content to be output by the television automatically and without user intervention.

In an implementation, a client device includes one or more modules to output a user interface to be displayed on a display device, in which the user interface is obtained from a particular website via a browser. The user interface is configured receive one or more inputs to select one or more of a plurality of client devices and select content to be streamed to the selected one or more client devices such that the selected content is to override local content selection at the one or more client devices.

In a further implementation, a client device comprises one or more modules to receive one or more inputs to locally select content. The one or more modules are to detect a notification that is to cause the local selection of the content to be overridden and to cause output of content selected by another client device via a website.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques to perform content selection and output.

FIG. 2 is an illustration of a system in an example implementation in which in which a client of FIG. 1 is illustrated as outputting a user interface to select content to be output by another client.

FIG. 3 is an illustration of a system in an example implementation in which the client of FIGS. 1 and 2 is illustrated as outputting a user interface to select another client to output the content selected in FIG. 2.

FIG. 4 is an illustration of a system in an example implementation showing output of the content selected using the user interface of FIG. 2 by the client selected using the user interface of FIG. 3.

FIG. 5 depicts a flowchart describing a procedure in an example implementation in which a user interface is used to select content and select a client device to output the content, the selected content then being used to override previous content that was output at the selected client.

### DETAILED DESCRIPTION

Overview

Users have access to a wide range of client devices to interact with a wide range of content, such as personal computers, mobile phones, game consoles, laptop computers, and so on. Additionally, these various devices may be used to interact with similar content, such as by accessing the Internet using the personal computers and mobile phones as previously described. However, interaction with the content using traditional techniques was performed within the bounds of the client itself and not shared with other clients. For example, a user may interact with a mobile phone to “surf” the Internet and locate a particular television program. Using traditional techniques, however, the user then interacted with the television to locate the same particular television program of interest, which was both inefficient and frustrating to the user.

Content selection and output techniques are described. In an implementation, techniques are described to allow a client to control content output by one or more other clients. For example, a user may navigate to a website and locate a particular television program of interest. The user may then specify that the particular television program is to be output and where that particular television program is to be output. For instance, a user may specify one or more client devices in the user's household, e.g., a television and a living room, a display device located in the refrigerator in a kitchen, and so on. In this way, a user is provided with techniques that unify content interaction between the user's devices.

In an implementation, the content selection and output techniques may be employed to override local selection of content at one or more client devices. Continuing with the previous example, for instance, the television program selected by the user of the mobile phone may override content that is currently being output by the one or more client devices that were selected in the user's household. Thus, the one or more other client devices may “follow orders” specified through a mobile phone. A variety of other content override techniques are also contemplated, further discussion of which may be found in relation to the following sections.

In the following discussion, an example environment and systems are first described that are operable to perform techniques to select and/or output content. Example procedures are then described that may be employed in the example environment, as well as in other environments. Although content selection and output is described in a television environment in the following discussion, it should be readily apparent that a wide variety of environments may be utilized without departing from the spirit and scope thereof.

### Example Environment

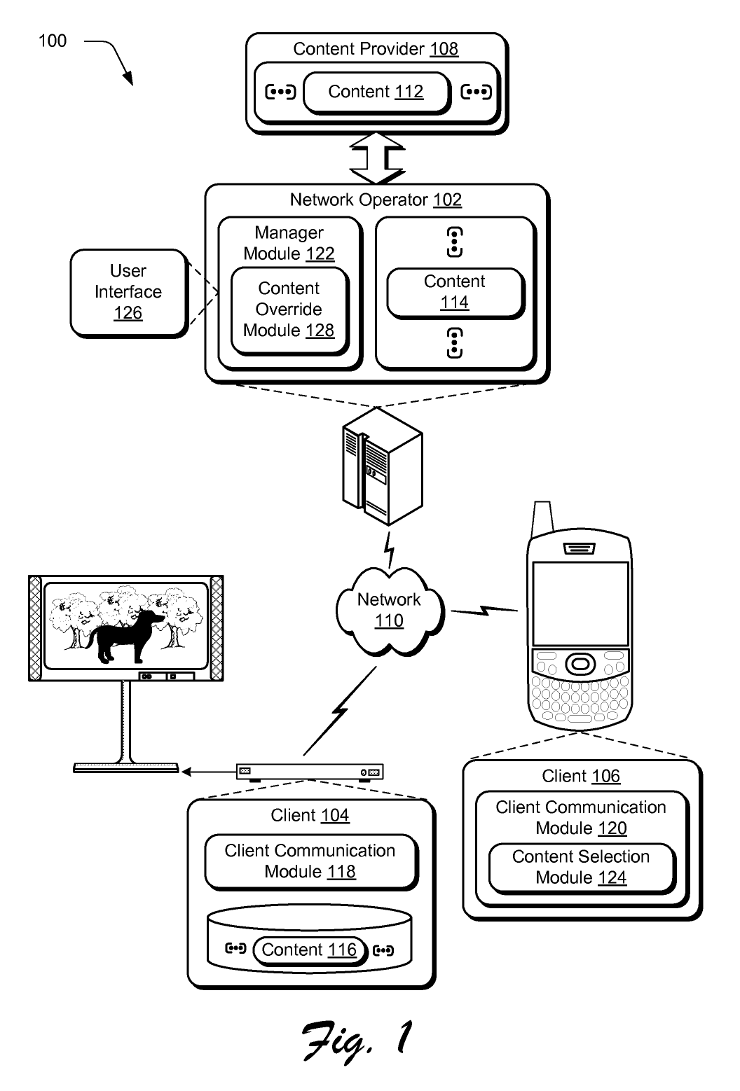

FIG. 1 is an illustration of an environment 100 in an example implementation that is operable to employ techniques to select and output content. The illustrated environment 100 includes a network operator 102 (e.g., a “head end”), first and second clients 104, 106 and a content provider 108. The network operator 102, the first client 104 and the second client 106 are illustrated as communicatively coupled, one to another, via a network 110.

Although a single network 110 is shown, the network 110 may be representative of a plurality of network connections that may be achieved using a single network or multiple networks, e.g., network 110 may be implemented via the Internet, a cable network, an “over the air” broadcast network, and so on. In the following discussion, the network operator 102, the clients 104, 106, the content provider 108 may also be representative of one or more entities, and therefore by convention reference may be made to a single entity (e.g., the client 104) or multiple entities (e.g., the clients 104, the plurality of clients 104, and so on).

The clients 104, 106 may be configured in a variety of ways. For example, the clients 104, 106 may be configured as a computer that is capable of communicating and/or receiving communications of data over the network 110, such as a television and set-top box as illustrated for client 104, a mobile station, an entertainment appliance (e.g., a game console), a set-top box communicatively coupled to a display device as illustrated, a wireless phone as illustrated for client 106, and so forth. Thus, the clients 104 may range from full resource devices with substantial memory and processor resources (e.g., television-enabled personal computers, television recorders equipped with hard disk) to a low-resource device with limited memory and/or processing resources (e.g., traditional set-top boxes).

Communication of content 112 to the clients 104, 106 may be performed in a variety of ways. For example, the clients 104, 106 may be communicatively coupled to the content provider 108 (which may be representative of one or more content providers) using a packet-switched network, e.g., the Internet. Accordingly, the clients 104, 106 may receive one or more items of content 112 directly from the content provider 108, e.g., via one or more websites. The content 112 may include a variety of data, such as television programming, video-on-demand (VOD) files, one or more results of remote application processing, and so on. A variety of other examples are also contemplated, such as by using an indirect distribution example in which the content 112 is communicated over the network connection 110 to the network operator 102.

Content 112, as illustrated in FIG. 1, is communicated to the network operator 102 (e.g., via a network connection and/or computer-readable media) and may be stored as one or more items of content 114. The content 114 may be the same as or different from the content 112 received from the content provider 108. The content 114, for instance, may include additional data for broadcast to the client 104. For example, the content 114 may include electronic program guide (EPG) data from an EPG database for broadcast to the client 104 utilizing a carousel file system and an out-of-band (OOB) channel. Distribution from the network operator 102 to the clients 104, 106 over network connection 112 may be accommodated in a number of ways, including cable, radio frequency (RF), microwave, digital subscriber line (DSL), and satellite using a variety of networks as previously described for network 110.

The clients 104, 106, as previously stated, may be configured in a variety of ways to receive the content 114 via the network 110. The clients 104, 106 typically include hardware and software to transport and decrypt content 114 received from the network operator 102 for output and/or rendering, e.g., by the illustrated display devices. Although display devices are shown, a variety of other output devices are also contemplated, such as speakers. Further, although the display device is illustrated separately from the client 104, it should be readily apparent that a client may also include the display device as an integral part thereof as illustrated for client 106.

The clients 104, 106 may also include personal video recorder (PVR) functionality. For instance, the client 104 is illustrated as including storage to record content 114 as content 116 received via the network 110 for output to and rendering by the display device. The storage may be configured in a variety of ways, such as a hard disk drive, a removable computer-readable medium (e.g., a medium (e.g., a writable digital video disc), and so on. Thus, content 116 that is stored in the storage device 120 of the client 104 may be copies of the content 114 that was streamed from the network operator 102. Additionally, content 116 may be obtained from a variety of other sources, such as from a computer-readable medium that is accessed by the client 104, and so on. For example, content 116 may be stored on a digital video disc (DVD) when the client 104 is configured to include writeable DVD functionality.

The clients 104, 106 include respective client communication modules 118, 120 that are representative of functionality of the respective clients 104, 106 to control content interaction, such as through the use of one or more “control functions”. The control functions may include a variety of functions to control output of content, such as to control volume, change channels, select different inputs, configure surround sound, and so on. The control functions may also provide non-linear playback of the content 116 (i.e., time shift the playback of the content 116) such as pause, rewind, fast forward, slow motion playback, and the like. For example, during a pause, the client 104 may continue to record the content 114 received via the network 110 in storage as content 116. The client 104, through execution of the client communication module 118, may then playback the content 116, starting at the point in time the content 116 was paused, while continuing to record the currently-broadcast content 114 in storage from the network operator 102.

When playback of the content 116 is requested, the client communication module 118 retrieves the content 116. The client communication module 118 may also restore the content 116 to the original encoded format as received from the content provider 108. For example, when the content 116 is recorded in storage, the content 116 may be compressed. Therefore, when the client communication module 118 retrieves the content 116, the content 116 is decompressed for rendering by the display device.

The network operator 102 is illustrated as including a manager module 122. The manager module 122 is representative of functionality to configure content 114 for output (e.g., streaming) over the network 110 to the client 104. The manager module 122, for instance, may configure content 112 received from the content provider 108 to be suitable for transmission over the network 110, such as to “packetize” the content 112 for distribution over the Internet, configuration for a particular broadcast channel, and so on.

Thus, in the environment 100 of FIG. 1, the content provider 108 may provide the content 112 to a multiplicity of network operators, an example of which is illustrated as network operator 102. The network operator 102 may then stream the content 114 over a network 110 to a multitude of clients, examples of which are illustrated as clients 104, 106. Client 104, for instance, may then store the content 114 in storage as content 116, such as when the client 104 is configured to include personal video recorder (PVR) functionality, and/or output the content 114 directly.

The client communication module 120 of client 106 is further illustrated as including a content selection module 124. The content selection module 124 is representative of functionality of the client 106 to select content for output by one or more other clients, e.g., client 104. For example, the client communication module 120 and/or the content selection module 124 may incorporate browser functionality to “surf” the network 110, e.g., when configured as the Internet. When surfing the network 110, the client 106 (through use of the client communication module 120 and/or the content selection module 124) may interact with a user interface 126 output by the manager module 122 of the network operator 102. The user interface 126 may be configured in a variety of ways, e.g., as a webpage, a dedicated interface that is local to the client 106, and so on.

The network operator 102, and more particularly the manager module 122, is further illustrated as including a content override module 128. The content override module 128 is representative of functionality of the network operator 102 to override local content selection at a client, e.g., client 104. In this way, the user interface 126 may provide for remote content selection, which may then be used by the content override module 128 to cause selected content to be output at another client, further discussion of which we found in relation to the following figure.

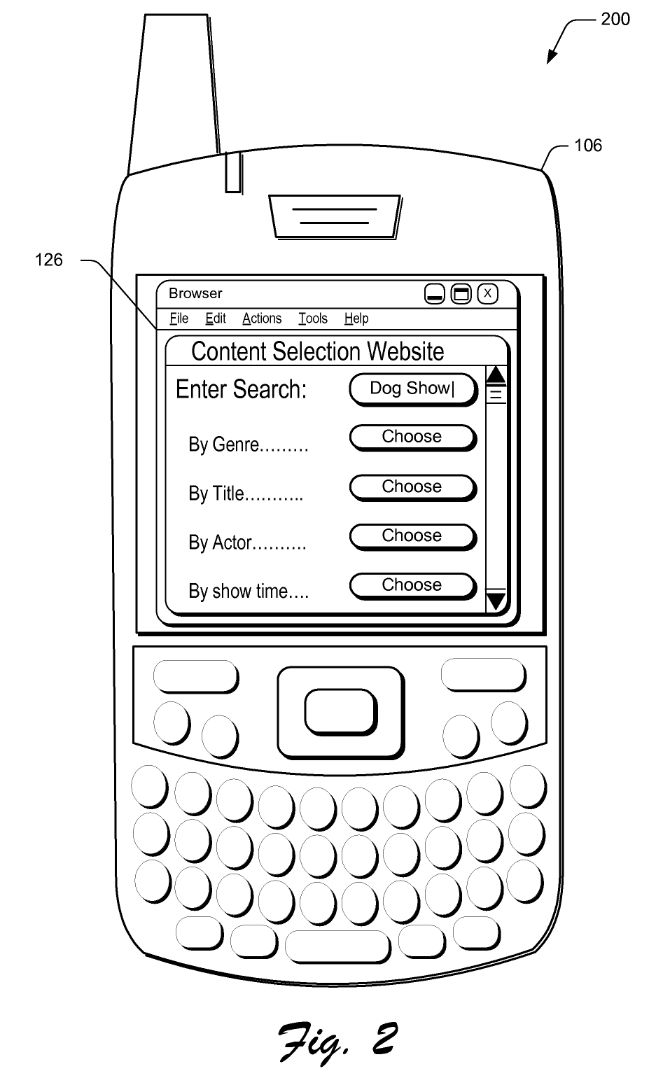

FIG. 2 depicts a system 200 in an example implementation in which the client 106 of FIG. 1 is illustrated as outputting the user interface 126 to select content to be output by client 104. The user interface 126 is illustrated as being output by the client communication module 120 when configured as a browser. The user interface 126, which in the illustrated instance of the system 200 is a webpage, configures the client communication module 120 to provide the previously described content selection module 124.

The user interface 126 includes the text “content selection website” which indicates that this particular webpage was obtained by a website provided by the network operator 102 of FIG. 1. The user interface 126 also includes a variety of different techniques that may be used to select particular content. For example, a user interface 126 includes a search box via which one or more keywords may be provided to search for particular content, the illustrated example of which includes the keywords “dog show”.

In the illustrated user interface 126 of FIG. 2, a variety of different options are also displayed to focus the search. For example, a user may choose to search by genre, by title, by actor, by show time, and so on. Thus, through interacting with the user interface 126 provided by the network operator 102, the client 106 may select particular content to be output by another client. The user interface 126 may also be utilized to select the other client that is to output the selected content, further discussion of which may be found in relation to the following figure.

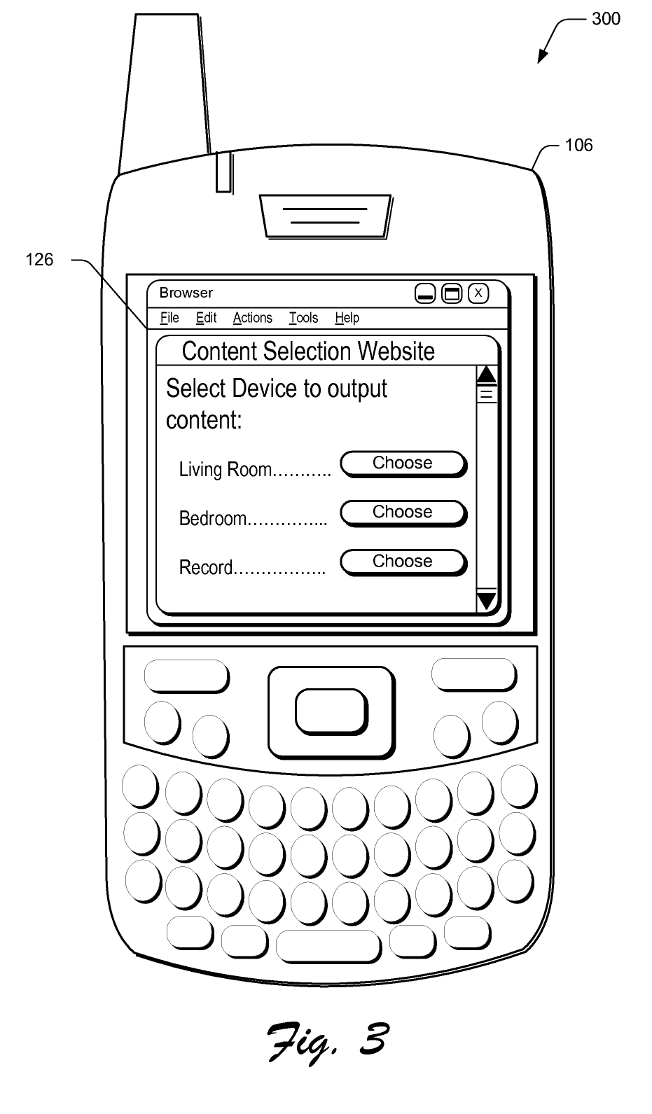

FIG. 3 depicts a system 300 in an example implementation in which the client 106 of FIGS. 1 and 2 is illustrated as outputting a user interface 126 to select another client to output the content selected in FIG. 2. The user interface 126 of FIG. 3 includes a variety of different options to select another client to output the content selected in FIG. 2. In the illustrated instance, the user interface 126 includes roams of a particular household, examples of which include “living room” and “bedroom”. An option is also provided for the user to cause the content to be recorded.

Although a particular household has been described, it should be readily apparent that a wide variety of collections of client devices are also contemplated that may or may not correspond to particular geographical locations. For example, the content selection website may be utilized to select from clients that are in the main office and/or branch office of a particular corporation, may include mobile devices that may roam to a variety of locations, and so on.

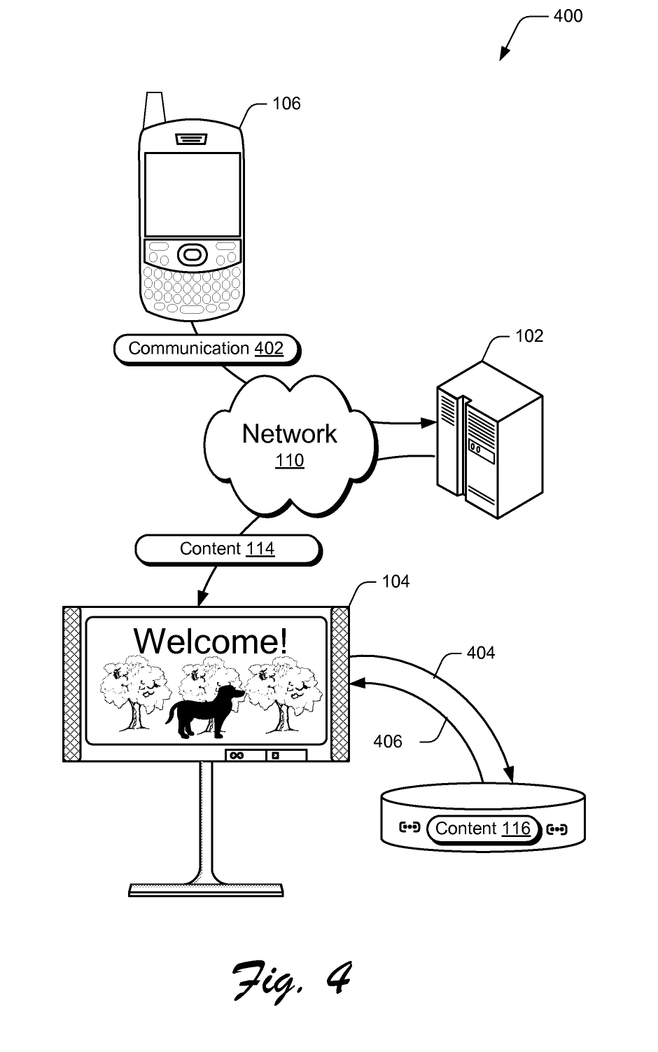

FIG. 4 depicts a system 400 in an example implementation showing output of the content selected using the user interface 126 of FIG. 2 by the client selected using the user interface 126 of FIG. 3. A communication 402 is illustrated as being communicated from the client 106 to the network operator 102 via network 110. The communication 402 may specify a particular item of content selected via the user interface 126 of FIG. 2.

In a first illustrated example, content 114 is streamed to the client 104 via the network 110. In an implementation, the content 114 is streamed instead of content that was previously output by the client 104. For instance, the content override module 128 may stream content 114 selected via the user interface 126 of FIG. 2 instead of content that was previously selected locally at the client 104.

In a second illustrated example, the content 114 selected via the user interface 126 of FIG. 2 is recorded 404 in the storage as content 116 by the client 104. In the third illustrated example, the content 116 selected via the user interface 126 of FIG. 2 is stored locally by the client 104. Accordingly, a communication may be sent by the network operator 102 to the client 104 to cause the selected content 116 to be output by the client 104. Thus, content selected via the user interface 126 of FIG. 2 may originate from a variety of different sources. A variety of other examples are also contemplated without departing from the spirit and scope thereof.

In an implementation, content selected via the user interface 126 overrides variety output of content that was previously selected, e.g., whether from the user interface 126 and/or locally at the client 104 itself. In this way, a user may interact with a single user interface output at a first client (e.g., client 106) to select and/or cause content to be output by another client (e.g., client 104) without manually interacting with the other client, e.g., such as to tune to a particular channel. Further discussion of content override may be found in relation to the following procedures.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques to select and output content are platform-independent, meaning that the techniques may be implemented on a variety of commercial computing platforms having a variety of processors.

Example Procedures

The following discussion describes personalization techniques that may be implemented utilizing the previously described environment, systems, user interfaces and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and systems 200-400 of FIGS. 2-4, respectively.

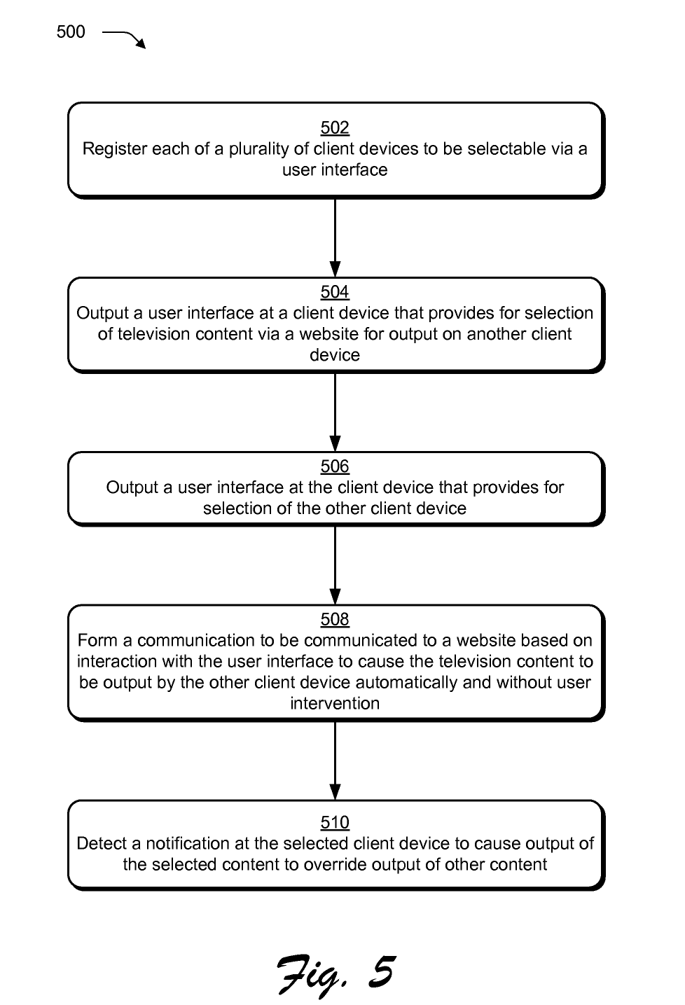

FIG. 5 depicts a procedure 500 in an example implementation in which a user interface is used to select content and select a client device to output the content, the selected content then being used to override previous content that was output at the selected client. Each of a plurality of client devices are registered, which are to be selectable via a user interface (block 502). For example, the user may interact with the user interface 126 of the network operator 102 of FIG. 1 and input an identifier (e.g., a MAC address) for each of the devices that are accessible by the user to output a particular type of content, e.g., television content such as sports programming, sitcoms, miniseries, and so on.

A user interface may then be output at a client device that provides for selection of television content via a website for output on another client device (block 504). The user interface 126, for instance, may be output as shown on the client 106 of FIG. 2 which is configured to receive one or more inputs to select content, e.g., by performing a search, selecting from an electronic program guide, highlighting a title in an article, and so on.

A user interface is output at the client device that provides for selection of the other client device (block 506), e.g., from a plurality of other clients. Continuing with the previous example, the user interface 126 as output by the client 106 of FIG. 3 provides for selection of the other client devices using one or more identifiers. In illustrated instance, the identifiers are based on an expected geographic location of the respective client device, such as “living room”, “bedroom”, and so on. A variety of other identifiers are also contemplated, such as a name of a user of the client device (e.g., a mobile phone), a brand-name of the client device, and so on.

A communication is formed to be communicated to a website based on interaction with the user interface to cause the television content to be output by the other client device automatically and without user intervention (block 508). The communication 402, for instance, may cause the network operator 102 to provide selected content to the client 104 to the exclusion of other content. In another instance, the network operator 102 may cause the client 104 to tune to a particular channel, access a particular website, and so on, without receiving one or more inputs from a user that is local to the client 104. A variety of other instances are also contemplated without departing from the spirit and scope thereof, examples of which were previously described in relation to FIG. 4.

In one such example, a notification is detected at the selected client device to cause output of the selected content to override output of other content (block 510). In the previous example, the content override is performed by the provision of different content by the network operator 102, e.g., replacing one stream with another. The content override may also be performed locally at the client 104 in response to a notification received from the network operator 102 and/or client 106, such as to tune to a particular channel, access a particular website, and so on without receiving one or more inputs locally at the client 104. A variety of other examples are also contemplated without departing from the spirit and scope thereof.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
outputting a user interface at a client device that provides for selection of television content via a website for output on another client device; and
forming a communication to be communicated to the website based on interaction with the user interface to cause the television content to be output by the other client device automatically and without user intervention.

2. The method as described in claim 1, wherein the other client device is not configured to output the user interface.

3. The method as described in claim 1, wherein the television content is to be output by the other client device automatically and without user intervention such that the television content is output without receiving an input by a user through the other client device by tuning to a particular channel.

4. The method as described in claim 1, wherein the television content is to be output by the other client device automatically and without user intervention such that the television content selected via the user interface is streamed to the other client device and not other television content that was not selected via the user interface.

5. The method as described in claim 1, wherein the user interface is output by the client device via a web browser.

6. The method as described in claim 1, wherein the user interface includes a listing of a plurality of other client devices that are accessible via the user interface to cause the television content selected via the user interface to be output.

7. The method as described in claim 6, wherein the user interface is configured to output the listing of a plurality of other client devices to select particular said of the client devices to output the television content.

8. The method as described in claim 6, further comprising registering each of the plurality of other client devices to be selectable via the user interface provided by the website.

9. The method as described in claim 1, wherein the communication causes the website to cause the television content to be output by the other client device such that local control of selection of television content at the other client device is overridden.

10. The method as described in claim 9, wherein the local control of the selection of the television content at the other client device is overridden such that the other client device is prevented from changing channels.

11. A client device comprising:
one or more modules to output a user interface, to be displayed on a display device and that was obtained from a particular website via a browser, which is configured receive one or more inputs to:
select one or more of a plurality of client devices; and
select content to be streamed to the selected one or more client devices such that the selected content is to override local content selection at the one or more client devices.

12. A client device as described in claim 11, wherein the particular website is associated with a head end that is to stream the selected content to the selected one or more client devices.

13. A client device as described in claim 11, wherein the selected one or more client devices do not include the client device that output the user interface.

14. A client device as described in claim 11, wherein at least one of the selected one or more client devices is not configured to output the user interface.

15. A client device as described in claim 11, wherein the local content selection is overridden such that at least one of the selected one or more client devices is not permitted to output content other than the selected content until output of the selected content has been completed.

16. A client device comprising one or more modules to:
receive one or more inputs to locally select content; and
detect a notification that is to cause:
the local selection of the content to be overridden; and
output of content selected by another client device via a website.

17. A client device as described in claim 16, wherein the local selection of the content is overridden such that content output when the notification is detected is replaced by the content selected by the other client device.

18. A client device as described in claim 16, wherein the local selection of the content is overridden until output of the content selected by the other client device is completed.

19. A client device as described in claim 16, wherein the local selection of the content is overridden such that the content selected by the other client device is output automatically without user selection by the one or more modules without receiving one or more inputs from a user.

20. A client device as described in claim 16, wherein the local selection of the content is overridden such that the content selected by the other client device is output automatically without user selection of a channel that is used to stream the content.
